(19) United States
(12) Patent Application Publication
(10) Pub. No.: US 2026/0018607 A1
(43) Pub. Date: Jan. 15, 2026

(54) ELECTROCHEMICAL DEVICE AND ELECTRONIC DEVICE

(71) Applicant: Ningde Amperex Technology Limited, Ningde (CN)

(72) Inventors: Jianyu LIU, Ningde (CN); Chao TANG, Ningde (CN); Guangcan LIU, Ningde (CN)

(73) Assignee: Ningde Amperex Technology Limited, Ningde (CN)

(21) Appl. No.: 19/333,490

(22) Filed: Sep. 19, 2025

Related U.S. Application Data
(63) Continuation of application No. PCT/CN2023/082446, filed on Mar. 20, 2023.

(51) Int. Cl. H01M 4/525; H01M 4/02; H01M 10/0525; H01M 10/0567; H01M 10/0568; H01M 10/0569; H01M 50/451; H01M 50/46; H01M 50/491

(52) U.S. Cl. CPC H01M 4/525; H01M 10/0525; H01M 10/0567; H01M 10/0568; H01M 10/0569; H01M 50/451; H01M 50/461; H01M 50/491; H01M 2004/028; H01M 2300/0028

(57) ABSTRACT

An electrochemical device including a positive electrode, a negative electrode, and an electrolyte, where the positive electrode includes a positive electrode active material, the positive electrode active material includes element manganese, and based on a mass of the positive electrode active material, a percentage of the element manganese is B %; the electrolyte includes carboxylate ester, and based on a mass of the electrolyte, a percentage of the carboxylate ester is C %; and 10≤C≤60 and 0.5≤C/100B≤6.

### CROSS REFERENCE TO THE RELATED APPLICATIONS

This application is a continuation under 35 U.S.C. § 120 of international patent application PCT/CN2023/082446 filed on Mar. 20, 2023, the entire content of which is incorporated herein by reference.

### TECHNICAL FIELD

The present application relates to the field of energy storage, and specifically to an electrochemical device and an electronic device.

### BACKGROUND

Electrochemical devices (for example, lithium-ion batteries) have characteristics such as high specific energy, high operating voltage, low self-discharge rate, small volume, and light weight, and are therefore widely used in various fields such as energy storage, portable electronic apparatuses, and electric vehicles. With the continuous expansion of the application scope of lithium-ion batteries, the market has imposed higher requirements on lithium-ion batteries, such as higher energy density and longer service life. However, increasing the operating cut-off voltage of lithium-ion batteries to increase their energy density typically has a detrimental effect on their high-temperature cycling performance or room-temperature cycling performance.

Simultaneously improving the high-temperature and room-temperature cycling performance of lithium-ion batteries under high voltage remains an unresolved challenge.

In view of this, it is indeed necessary to provide an electrochemical device with improved high-temperature and room-temperature cycling performance under high voltage.

### SUMMARY

The present application aims to address at least one of the problems existing in the related field to at least some extent by providing an electrochemical device and an electronic device.

According to one aspect of the present application, the present application provides an electrochemical device including a positive electrode, a negative electrode, and an electrolyte, where the positive electrode includes a positive electrode active material, the positive electrode active material contains element manganese, and based on a mass of the positive electrode active material, a percentage of the element manganese is B %; the electrolyte includes carboxylate ester, and based on a mass of the electrolyte, a percentage of the carboxylate ester is C %; and 10≤C≤60 and 0.5≤ C/100B≤6.

According to an embodiment of the present application, 1≤C/100B≤3.

According to an embodiment of the present application, the positive electrode active material further includes element cobalt, and based on the mass of the positive electrode active material, a percentage of the element cobalt is A %, and 10≤ A/20B≤60 and 0.05≤B≤0.3.

According to an embodiment of the present application, 15≤A/20B≤30.

According to an embodiment of the present application, the positive electrode active material has a formula Li_{α}Co_{1-x-y}MnₓM_{y}O_{β}, where 0.95≤α≤1.4, 0<x≤0.4, 0≤y≤0.3, 1.90≤B≤2.10, and M is at least one selected from Mg, Al, Ca, Ti, Zr, V, Cr, Fe, Ni, Cu, Zn, Ru, or Sn.

According to an embodiment of the present application, the carboxylate ester includes at least one of methyl acetate, ethyl acetate, propyl acetate, ethyl propionate, propyl propionate, butyl propionate, pentyl propionate, halomethyl acetate, haloethyl acetate, halopropyl acetate, haloethyl propionate, halopropyl propionate, halobutyl propionate, or halopentyl propionate.

According to an embodiment of the present application, the electrolyte further includes at least one of 1,3-propane sultone, vinyl sulfate, vinylene carbonate, a bicyclic carbonate compound, or a bicyclic sulfate compound.

According to an embodiment of the present application, the electrolyte satisfies at least one of the following conditions:
(a) based on the mass of the electrolyte, a percentage of the 1,3-propane sultone is 0.5% to 5%;
(b) based on the mass of the electrolyte, a percentage of the vinyl sulfate is 0.1% to 1%;
(c) based on the mass of the electrolyte, a percentage of the vinylene carbonate is 0.1% to 1%;
(d) based on the mass of the electrolyte, a percentage of the bicyclic carbonate compound is 0.1% to 30%; or
(e) based on the mass of the electrolyte, a percentage of the bicyclic sulfate compound is 0.1% to 5%.

According to an embodiment of the present application, the bicyclic carbonate compound includes at least one of the following compounds:

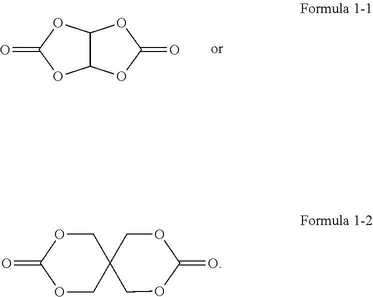 [SMILES: O=C1OC2OC(=O)OC2O1 ; O=C1OCC2(CO1)COC(=O)OC2]

According to an embodiment of the present application, the bicyclic sulfate compound includes at least one of the following compounds:

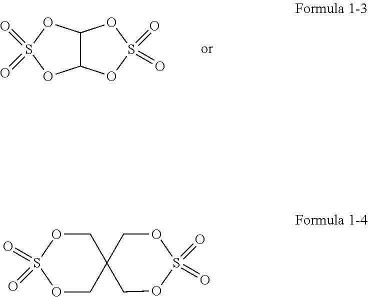 [SMILES: O=S1(=O)OC2OS(=O)(=O)OC2O1 ; O=S1(=O)OCC2(CO1)COS(=O)(=O)OC2]

According to an embodiment of the present application, the electrolyte further includes a trinitrile compound, where the trinitrile compound includes at least one of 1,3,5-pentanetricarbonitrile, 1,2,3-propanetricarbonitrile, 1,3,6-hexanetricarbonitrile, or 1,2,3-tris(2-cyanoethoxy) propane; and based on the mass of the electrolyte, a percentage of the trinitrile compound is 0.1% to 10%.

According to an embodiment of the present application, the electrolyte further includes a lithium salt, where the lithium salt includes at least one of lithium hexafluorophosphate, lithium bis(trifluoromethanesulfonyl)imide, lithium bis(fluorosulfonyl)imide, lithium tetrafluoroborate, lithium bis(oxalato) borate, lithium difluoro (oxalato) borate, or lithium difluorophosphate; and based on the mass of the electrolyte, a percentage of the lithium salt is 10% to 15%.

According to an embodiment of the present application, the electrochemical device further includes a separator, where the separator includes a porous substrate and a porous coating disposed on at least one side of the porous substrate, and the porous coating includes inorganic particles and a fluorine-containing binder.

According to an embodiment of the present application, the inorganic particles include at least one of magnesium hydroxide, boehmite, or aluminum oxide, and the fluorine-containing binder is a polyvinylidene fluoride-based binder.

According to an embodiment of the present application, an adhesion strength between the porous coating and the positive electrode or the negative electrode is 4 N/m to 20 N/m.

According to another aspect of the present application, the present application provides an electronic device including the electrochemical device according to the present application.

Additional aspects and advantages of the present application will be partially described or presented in the subsequent descriptions, or explained through the implementation of some embodiments of the present application.

### DETAILED DESCRIPTION

Some embodiments of the present application will be described in detail below. These embodiments of the present application should not be construed as limiting the present application.

In the specific embodiments and claims, a list of items connected by the term “at least one of” may mean any combination of the listed items. For example, if items A and B are listed, the phrase “at least one of A and B” means only A; only B; or A and B. In another example, if items A, B, and C are listed, the phrase “at least one of A, B, and C” means only A; or only B; only C; A and B (excluding C); A and C (excluding B); B and C (excluding A); or all of A, B, and C. Item A may include a single element or a plurality of elements. Item B may include a single element or a plurality of elements. Item C may include a single element or a plurality of elements.

With the expansion of application fields for electrochemical devices (for example, lithium-ion batteries), higher requirements have been placed on their energy density. Increasing the operating cut-off voltage of lithium-ion batteries is one method to increase their energy density. However, as the voltage increases, the cycling stability of lithium-ion batteries, particularly their high-temperature cycling performance, deteriorates. Doping the positive electrode can help to address this issue. However, increasing the doping elements gradually worsens the kinetics of lithium-ion batteries, thereby adversely affecting their room-temperature cycling performance.

To address the above issues, the present application provides an electrochemical device including a positive electrode, a negative electrode, and an electrolyte, where the positive electrode includes a positive electrode active material, the positive electrode active material includes element manganese, and based on a mass of the positive electrode active material, a percentage of the element manganese is B %; the electrolyte includes carboxylate ester, and based on a mass of the electrolyte, a percentage of the carboxylate ester is C %; and 10≤C≤60 and 0.5≤C/100B≤6.

Doping the positive electrode active material with element manganese can enhance the high-temperature cycling stability of the positive electrode material under high voltage, possibly because element manganese helps to stabilize oxygen elements, thereby enhancing the structural stability of the positive electrode active material. Introducing the carboxylate ester into the electrolyte can reduce the viscosity of the electrolyte, enhance lithium-ion transmission capability, improve the conductivity of the electrolyte, compensate for the adverse effects of metal element doping on the kinetics of the electrochemical device, and reduce battery polarization, thereby improving the room-temperature cycling performance of the electrochemical device. By adjusting the relationship between the percentage of the carboxylate ester in the electrolyte and the percentage of element manganese in the positive electrode active material, improvement in both the high-temperature cycling performance and the room-temperature cycling performance of the electrochemical device under high voltage can be achieved.

The present application has no particular restrictions on the preparation method of the positive electrode active material doped with element manganese (hereinafter referred to as the modified positive electrode active material), and preparation methods known to those skilled in the art can be used. For example, a manganese-containing compound (for example, Mn₃O₄) may be added to the positive electrode active material LiCoO₂ to obtain the modified positive electrode active material. Additionally, the present application can adjust the percentage of manganese doping element in the modified positive electrode active material, for example, by adjusting the amount of the manganese-containing compound added, to achieve variations in the manganese doping element in the positive electrode active material layer. The present application does not specifically limit the adjustment process, as long as it achieves the purpose of the present application.

In some embodiments, 1≤C/100B≤3. In some embodiments, C/100B is 0.5, 1, 1.5, 2, 2.5, 3, 3.5, 4, 4.5, 5, 5.5, 6, or within a range defined by any two of the above values. Controlling C/100B to be within the above range helps to further improve the high-temperature and room-temperature cycling performance of the electrochemical device under high voltage.

In some embodiments, 20≤C≤50. In some embodiments, 30≤C≤40. In some embodiments, C is 10, 15, 20, 25, 30, 35, 40, 45, 50, 55, 60, or within a range defined by any two of the above values.

In some embodiments, the positive electrode active material further includes element cobalt, and based on the mass of the positive electrode active material, a percentage of the element cobalt is A %, and 10≤A/20B≤60 and 0.05≤B≤0.3.

In some embodiments, 15≤A/20B≤30. In some embodiments, A/20B is 10, 15, 20, 25, 30, 35, 40, 45, 50, 55, 60, or within a range defined by any two of the above values. Controlling A/20B to be within the above range helps to further enhance the structural stability of the positive electrode active material, thereby further improving the high-temperature and room-temperature cycling performance of the electrochemical device under high voltage.

In some embodiments, 0.1≤B≤0.2. In some embodiments, B is 0.05, 0.1, 0.15, 0.2, 0.25, 0.3, or within a range defined by any two of the above values.

In some embodiments, 59≤A≤61. In some embodiments, A is 59, 59.5, 60, 60.5, 61, or within a range defined by any two of the above values.

In some embodiments, the positive electrode active material has a formula Li_{α}Co_{1-x-y}MnₓMO_{β}, where 0.95≤α≤1.4, 0≤x≤0.4, 0≤y≤0.3, 1.90≤β≤2.10, and M is selected from at least one of Mg, Al, Ca, Ti, Zr, V, Cr, Fe, Ni, Cu, Zn, Ru, or Sn.

In some embodiments, α is 0.95, 1.05, 1.2, 1.4, or within a range defined by any two of the above values.

In some embodiments, x is 0.01, 0.05, 0.1, 0.2, 0.4, or within a range defined by any two of the above values.

In some embodiments, y is 0, 0.01, 0.05, 0.1, 0.2, 0.3, or within a range defined by any two of the above values.

In some embodiments, β is 1.90, 1.95, 2.00, 2.05, 2.10, or within a range defined by any two of the above values.

In some embodiments, the carboxylate ester includes at least one of methyl acetate, ethyl acetate, propyl acetate, ethyl propionate, propyl propionate, butyl propionate, pentyl propionate, halomethyl acetate, haloethyl acetate, halopropyl acetate, haloethyl propionate, halopropyl propionate, halobutyl propionate, or halopentyl propionate.

In some embodiments, the electrolyte further includes ethylene carbonate and propylene carbonate, where based on the mass of the electrolyte, a percentage of the ethylene carbonate is D %, a percentage of the propylene carbonate is E %, and 10≤D+E≤40 and D≥E.

In some embodiments, D+E is 10, 20, 30, 40, or within a range defined by any two of the above values.

In some embodiments, 0≤D≤30. In some embodiments, 5≤D≤25. In some embodiments, 10≤D≤20. In some embodiments, D is 0, 5, 10, 15, 20, 25, 30, or within a range defined by any two of the above values.

In some embodiments, 0≤E≤30. In some embodiments, 5≤E≤25. In some embodiments, 10≤E≤20. In some embodiments, E is 0, 5, 10, 15, 20, 25, 30, or within a range defined by any two of the above values.

Adjusting the amounts of ethylene carbonate and propylene carbonate in the electrolyte can enhance the interface protection of the negative electrode, reduce the consumption rate of the electrolyte, and further enhance the improvement in the room-temperature cycling performance of the electrochemical device under high voltage.

In some embodiments, the electrolyte further includes at least one of 1,3-propane sultone, vinyl sulfate, vinylene carbonate, a bicyclic carbonate compound, or a bicyclic sulfate compound.

In some embodiments, based on the mass of the electrolyte, a percentage of the 1,3-propane sultone is 0.5% to 5%. In some embodiments, based on the mass of the electrolyte, the percentage of the 1,3-propane sultone is 1% to 3%. In some embodiments, based on the mass of the electrolyte, the percentage of the 1,3-propane sultone is 0.5%, 1%, 1.5%, 2%, 2.5%, 3%, 3.5%, 4%, 4.5%, 5%, or within a range defined by any two of the above values.

In some embodiments, based on the mass of the electrolyte, a percentage of the vinyl sulfate is 0.1% to 1%. In some embodiments, based on the mass of the electrolyte, the percentage of the vinyl sulfate is 0.3% to 0.6%. In some embodiments, based on the mass of the electrolyte, the percentage of the vinyl sulfate is 0.1%, 0.3%, 0.5%, 0.8%, 1%, or within a range defined by any two of the above values.

In some embodiments, based on the mass of the electrolyte, a percentage of the vinylene carbonate is 0.1% to 1%. In some embodiments, based on the mass of the electrolyte, the percentage of the vinylene carbonate is 0.3% to 0.6%. In some embodiments, based on the mass of the electrolyte, the percentage of the vinylene carbonate is 0.1%, 0.3%, 0.5%, 0.8%, 1%, or within a range defined by any two of the above values.

In some embodiments, based on the mass of the electrolyte, a percentage of the bicyclic carbonate compound is 0.1% to 30%. In some embodiments, based on the mass of the electrolyte, the percentage of the bicyclic carbonate compound is 0.5% to 25%. In some embodiments, based on the mass of the electrolyte, the percentage of the bicyclic carbonate compound is 1% to 20%. In some embodiments, based on the mass of the electrolyte, the percentage of the bicyclic carbonate compound is 5% to 15%. In some embodiments, based on the mass of the electrolyte, the percentage of the bicyclic carbonate compound is 10% to 12%. In some embodiments, based on the mass of the electrolyte, the percentage of the bicyclic carbonate compound is 0.1%, 0.5%, 1%, 5%, 10%, 15%, 20%, 25%, 30%, or within a range defined by any two of the above values.

In some embodiments, based on the mass of the electrolyte, a percentage of the bicyclic sulfate compound is 0.1% to 5%. In some embodiments, based on the mass of the electrolyte, the percentage of the bicyclic sulfate compound is 0.5% to 2%. In some embodiments, based on the mass of the electrolyte, the percentage of the bicyclic sulfate compound is 0.1%, 0.5%, 1%, 1.5%, 2%, 2.5%, 3%, 3.5%, 4%, 4.5%, 5%, or within a range defined by any two of the above values.

Controlling the percentage of the 1,3-propane sultone, vinyl sulfate, vinylene carbonate, bicyclic carbonate compound, or bicyclic sulfate compound in the electrolyte to be within the above range helps to further improve the high-temperature and room-temperature cycling performance of the electrochemical device under high voltage.

In some embodiments, the bicyclic carbonate compound includes at least one of the following compounds:

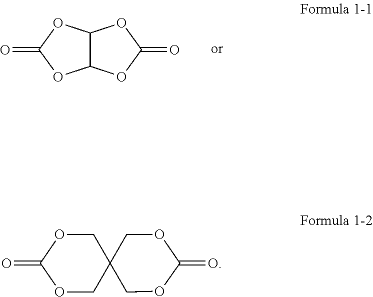 [SMILES: O=C1OC2OC(=O)OC2O1 ; O=C1OCC2(CO1)COC(=O)OC2]

In some embodiments, the bicyclic sulfate compound includes at least one of the following compounds:

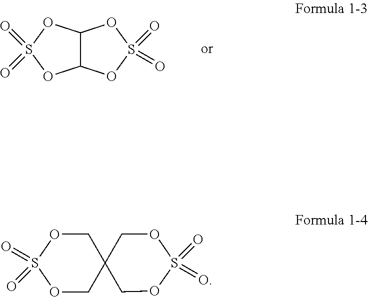 [SMILES: O=S1(=O)OC2OS(=O)(=O)OC2O1 ; O=S1(=O)OCC2(CO1)COS(=O)(=O)OC2]

In some embodiments, the electrolyte further includes a trinitrile compound, where the trinitrile compound includes at least one of 1,3,5-pentanetricarbonitrile

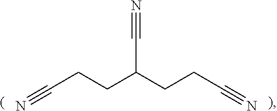 [SMILES: N#CCCC(C#N)CCC#N]

1,2,3-propanetricarbonitrile

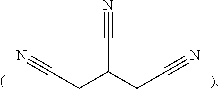

1,3,6-hexanetricarbonitrile

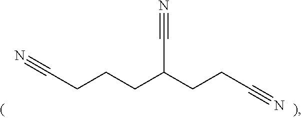 [SMILES: N#CCCCC(C#N)CCC#N]

or 1,2,3-tris(2-cyanoethoxy) propane

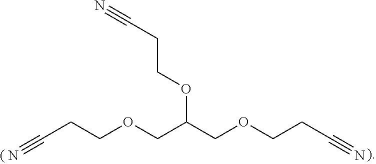 [SMILES: N#CCCOCC(COCCC#N)OCCC#N]

In some embodiments, based on the mass of the electrolyte, a percentage of the trinitrile compound is 0.1% to 10%. In some embodiments, based on the mass of the electrolyte, the percentage of the trinitrile compound is 0.1%, 0.2%, 0.5%, 1%, 1.5%, 2%, 2.5%, 3%, 3.5%, 4%, 4.5%, 5%, 5.5%, 6%, 8%, 9%, 10%, or within a range defined by any two of these values. When the electrolyte includes a trinitrile compound, it helps to further improve the high-temperature and room-temperature cycling performance of the electrochemical device under high voltage.

In some embodiments, the electrolyte further includes a lithium salt, where the lithium salt includes at least one of lithium hexafluorophosphate, lithium bis(trifluoromethanesulfonyl)imide, lithium bis(fluorosulfonyl)imide, lithium tetrafluoroborate, lithium bis(oxalato) borate, lithium difluoro (oxalato) borate, or lithium difluorophosphate.

In some embodiments, based on the mass of the electrolyte, a percentage of the lithium salt is 10% to 15%. In some embodiments, based on the mass of the electrolyte, the percentage of the lithium salt is 12% to 15%. With the percentage of the lithium salt being within the above range, the electrolyte has suitable ionic conductivity and viscosity, which helps to improve the room-temperature cycling performance of the electrochemical device.

In some embodiments, the positive electrode includes a positive electrode current collector and a positive electrode active material layer disposed on the positive electrode current collector. The positive electrode active material layer may be disposed on one side or two sides of the positive electrode current collector. The positive electrode current collector in the present application is not particularly limited and may be any positive electrode current collector in the art, such as aluminum foil, aluminum alloy foil, or composite current collector. In some embodiments, a thickness of the positive electrode current collector may be 1 μm to 200 μm.

In some embodiments, the positive electrode active material layer may be applied on only a partial region of the positive electrode current collector. In some embodiments, the thickness of the positive electrode active material layer may be 10 μm to 500 μm. It should be understood that this is merely an example, and any other suitable thickness may be adopted.

In some embodiments, the positive electrode active material layer further includes a binder and a conductive agent. In some embodiments, the binder in the positive electrode active material layer may include at least one of polyvinylidene fluoride, a vinylidene fluoride-hexafluoropropylene copolymer, a styrene-acrylate copolymer, a styrene-butadiene copolymer, polyamide, polyacrylonitrile, polyacrylate, polyacrylic acid, polyacrylate salt, sodium carboxymethyl cellulose, polyvinyl acetate, polyvinylpyrrolidone, polyvinyl ether, polymethyl methacrylate, polytetrafluoroethylene, or polyhexafluoropropylene. In some embodiments, the conductive agent in the positive electrode active material layer may include at least one of conductive carbon black, acetylene black, Ketjen black, flake graphite, graphene, carbon nanotubes, or carbon fibers. In some embodiments, a mass ratio of the positive electrode active material, conductive agent, and binder in the positive electrode active material layer may be (70-98):(1-15):(1-15). It should be understood that the descriptions above are merely examples, and any other suitable material, thickness, and mass ratio may be adopted for the positive electrode active material layer.

In some embodiments, the negative electrode may include a negative electrode current collector and a negative electrode active material layer disposed on the negative electrode current collector. The negative electrode active material layer may be disposed on one side or two sides of the negative electrode current collector. The negative electrode current collector in the present application is not particularly limited, and materials such as metal foil or porous metal plate may be used, for example, foils or porous plates of metals such as copper, nickel, titanium, or iron, or their alloys, such as copper foil. In some embodiments, a thickness of the negative electrode current collector may be 1 μm to 200 μm.

In some embodiments, the negative electrode active material layer may be applied on only a partial region of the negative electrode current collector. In some embodiments, the thickness of the negative electrode active material layer may be 10 μm to 500 μm. It should be understood that this is merely an example, and any other suitable thickness may be adopted.

In some embodiments, the negative electrode active material layer includes a negative electrode active material. In some embodiments, the negative electrode active material in the negative electrode active material layer includes at least one of lithium metal, natural graphite, artificial graphite, or a silicon-based material. In some embodiments, the silicon-based material includes at least one of silicon, a silicon-oxygen compound, a silicon-carbon compound, or a silicon alloy.

In some embodiments, the negative electrode active material layer may further include a conductive agent, a binder, and/or a thickener. The conductive agent in the negative electrode active material layer may include at least one of carbon black, acetylene black, Ketjen black, flake graphite, graphene, carbon nanotubes, carbon fibers, or carbon nanowires. In some embodiments, the binder in the negative electrode active material layer may include at least one of styrene-butadiene rubber (SBR), polyvinylidene fluoride (PVDF), polytetrafluoroethylene (PTFE), polyvinyl butyral (PVB), water-based acrylic resin, or carboxymethyl cellulose (CMC). In some embodiments, the thickener in the negative electrode active material layer may be carboxymethyl cellulose (CMC). It should be understood that the materials disclosed above are merely examples, and any other suitable material may be used for the negative electrode active material layer.

In some embodiments, the electrochemical device further includes a separator, where the separator includes a porous substrate and a porous coating disposed on at least one side of the porous substrate, and the porous coating includes inorganic particles and a fluorine-containing binder. In some embodiments, a mass ratio of inorganic particles to fluorine-containing binder in the porous coating may be (30-90):(70-10). The adhesive porous coating can enhance the heat resistance, oxidation resistance, and electrolyte wettability of the separator, as well as improve the adhesion between the separator and the electrode plate.

In some embodiments, the inorganic particles include at least one of magnesium hydroxide, boehmite, or aluminum oxide, and the fluorine-containing binder is a polyvinylidene fluoride-based binder.

In some embodiments, an adhesion strength between the porous coating and the positive electrode or the negative electrode is 4 N/m to 20 N/m. In some embodiments, the adhesion strength between the porous coating and the positive electrode or the negative electrode is 5 N/m to 10 N/m. In some embodiments, the adhesion strength between the porous coating and the positive electrode or the negative electrode is 4 N/m, 5 N/m, 8 N/m, 10 N/m, 12 N/m, 15 N/m, 20 N/m, or within a range defined by any two of the above values.

In some embodiments, a thickness of the porous coating is in the range of 1 μm to 5 μm. In some embodiments, the thickness of the porous coating is 1 μm, 2 μm, 3 μm, 4 μm, 5 μm, or within a range defined by any two of the above values.

In some embodiments, the separator includes at least one of polyethylene (PE), polypropylene (PP), polyethylene terephthalate (PET), polyimide (PI), or aramid. For example, the polyethylene includes at least one of high-density polyethylene, low-density polyethylene, or ultra-high molecular weight polyethylene. In particular, the polyethylene and polypropylene have a good effect in preventing short circuits and can enhance the stability of the battery through a shutdown effect.

In some embodiments, a thickness of the separator is in the range of 3 μm to 20 μm. In some embodiments, the thickness of the separator is 3 μm, 5 μm, 10 μm, 15 μm, 20 μm, or within a range defined by any two of the above values.

The present application further provides an electronic device including the electrochemical device described in the present application. The electronic device of some embodiments of the present application is not particularly limited and can be any electronic device known in the prior art. In some embodiments, the electronic device may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, or a lithium-ion capacitor.

The preparation processes of the electrochemical device and the electronic device are well known to those skilled in the art, and the present application has no particular limitations. For example, a lithium-ion battery may be manufactured through the following process: a positive electrode and a negative electrode are stacked with a separator therebetween, and the stack is put into a housing after operations such as winding and folding as needed. The housing is injected with an electrolyte and then sealed. In addition, an over-current protection element, a guide plate, or the like may also be placed into the housing as needed, so as to prevent a pressure inside the lithium-ion battery from rising too high, and the lithium-ion battery from over-charging and over-discharging.

The preparation of a lithium-ion battery is described below as an example, combined with specific embodiments, and those skilled in the art will understand that the preparation methods described in the present application are merely examples, and any other suitable preparation methods are within the scope of the present application.

### EXAMPLES

The following describes the performance evaluation of lithium-ion batteries according to the examples and comparative examples of the present application.

### I. Preparation of Lithium-Ion Battery

### 1. Preparation of Positive Electrode

For an undoped positive electrode active material, lithium cobaltate (LiCoO₂) was used as the positive electrode active material.

For a doped positive electrode active material, lithium cobaltate (LiCoO₂) and an oxide containing a metal element (manganese tetroxide Mn₃O₄) were mixed in a certain proportion and blended at 300 r/min for 20 min in a high-speed mixer, and the resulting mixture was placed in an air kiln, heated to 820° C. at 5° C./min, held for 24 h, naturally cooled, and then taken out for sieving through a 300-mesh sieve to obtain a modified positive electrode active material (that is, modified lithium cobaltate).

The positive electrode active material, conductive agent carbon nanotubes (CNT), and polyvinylidene fluoride (PVDF) were mixed at a weight ratio of 95:2:3, with N-methylpyrrolidone (NMP) added as a solvent, and the resulting mixture was stirred under a vacuum mixer until a uniform system with a solid content of 75 wt % was formed, resulting in a positive electrode slurry. The positive electrode slurry was evenly applied on one side of a 12 μm thick aluminum foil positive electrode current collector, dried at 85° C., and cold-pressed to obtain a positive electrode active material layer with a thickness of 100 μm, resulting in a positive electrode plate. The above steps were repeated on the other side of the positive electrode plate to obtain a double-sided positive electrode plate coated with the positive electrode active material layer. The positive electrode plate was cut to samples of 74 mm×867 mm, and tabs were welded for later use.

### 2. Preparation of Negative Electrode

Artificial graphite, styrene-butadiene rubber (SBR), and carboxymethyl cellulose (CMC) were mixed at a mass ratio of 95:2:3, with deionized water added as a solvent to prepare a slurry with a solid content of 70 wt %, and the slurry was stirred evenly. The slurry was evenly applied on one side of an 8 μm thick copper foil, dried at 110° C., and cold-pressed to obtain a negative electrode active material layer with a thickness of 150 μm, resulting in a single-sided negative electrode plate coated with the negative electrode active material layer. The application steps were repeated on the other side of the negative electrode plate to obtain a double-sided negative electrode plate coated with the negative electrode active material layer. The negative electrode plate was cut to samples of 74 mm×867 mm, and tabs were welded for later use. The defect degree Id/Ig of the negative electrode plate was 0.17.

### 3. Preparation of Separator

A 15 μm thick polyethylene (PE) porous polymer film was used as the separator.

According to the settings of the examples in Table 3, a certain amount of binder was dispersed in a solvent system, with a corresponding amount of inorganic particles added, and the resulting mixture was thoroughly stirred and mixed evenly, and then applied on one side or two surfaces of the separator substrate, followed by drying to obtain a separator with a porous coating.

### 4. Preparation of Electrolyte

In an argon atmosphere glovebox with a water content of less than 10 ppm, ethylene carbonate (EC), propylene carbonate (PC), diethyl carbonate (DEC), and carboxylate ester were evenly mixed at a weight ratio of 20:20:(60-C):C as the base solvent, with LiPF₆ added, and the resulting mixture was stirred evenly to produce an electrolyte, where a concentration of LiPF₆ was 12.5 wt %. The type and percentage C % of the carboxylate ester were set according to the requirements of each of the examples and comparative examples.

Additional components were added to the base electrolyte according to the settings of each of the examples or comparative examples to obtain the electrolyte.

### 5. Preparation of Lithium-Ion Battery

The positive electrode plate, the separator, and the negative electrode plate were stacked in order, with the separator placed between the positive electrode plate and the negative electrode plate for isolation, and the stack was wound to obtain an electrode assembly. The electrode assembly was placed in an aluminum-plastic film packaging bag, moisture was removed at 80° C., the prepared electrolyte was injected, and the battery was vacuum-sealed, allowed to stand, formed, and shaped to obtain a lithium-ion battery.

### II. Test Methods

### 1. Test Method for Percentages of Doping Elements in Positive Electrode Active Material

The active material of the positive electrode plate, washed with dimethyl carbonate (DMC), was scraped off with a scraper and dissolved in a mixed solvent (for example, 0.4 g of positive electrode active material was dissolved in a mixed solvent of 10 ml of aqua regia (nitric acid and hydrochloric acid mixed at 1:1) and 2 ml of HF), diluted to 100 mL, and then the percentage of metal elements such as Co or Mn in the solution was tested using an ICP analyzer, with the unit being ppm.

### 2. Test Method for High-Temperature Cycling Performance of Lithium-Ion Battery

At 45° C., the lithium-ion battery was charged at 0.7 C (rate) to 4.5 V, then charged at constant voltage until the current reached 0.05 C, and discharged at a constant current of 1 C to 3.0 V, constituting one charge-discharge cycle. The discharge capacity of the first cycle of the lithium-ion battery was recorded. The lithium-ion battery was subjected to charge-discharge cycles according to the above method, and the discharge capacity of each cycle was recorded until the discharge capacity of the lithium-ion battery decayed to 80% of the discharge capacity of the first cycle, and the number of charge-discharge cycles was recorded.

### 3. Test Method for Room-Temperature Cycling Performance of Lithium-Ion Battery

At 25° C., the lithium-ion battery was charged at 0.7 C (rate) to 4.5 V, then charged at constant voltage until the current reached 0.05 C, and discharged at a constant current of 1 C to 3.0 V, constituting one charge-discharge cycle. The discharge capacity of the first cycle of the lithium-ion battery was recorded. The lithium-ion battery was subjected to charge-discharge cycles according to the above method, and the discharge capacity of each cycle was recorded until the discharge capacity of the lithium-ion battery decayed to 80% of the discharge capacity of the first cycle, and the number of charge-discharge cycles was recorded.

### III. Test Results

Table 1 shows the effects of the percentage of the carboxylate ester in the electrolyte and its relationship with the doping percentage of the metal element in the positive electrode active material on the high-temperature and room-temperature cycling performance of lithium-ion batteries under high voltage.

TABLE 1

| | | | Percentages | | | | | | | |
|---|---|---|---|---|---|---|---|---|---|---|
| | Percentage | Percentage | of other | | | | | | | |
| | A of Co in | B of Mn in | doping | | | | | | | |
| | positive | positive | elements M | | | | | | | |
| | electrode | electrode | in positive | | Carboxylate ester in | | | | | |
| | active | active | electrode | | electrolyte | | | | High- | Room- |
| | material | material | material (%) | | | Percentage | | | temperature | temperature |
| | (%) | (%) | Mg | Al | Type | C (%) | C/100B | A/20B | cycle count | cycle count |
| Example 1 | 59.7 | 0.3 | 0 | 0 | PP | 30 | 1 | 10 | 555 | 730 |
| Example 2 | 59.7 | 0.2 | 0 | 0 | PP | 30 | 1.5 | 15 | 550 | 760 |
| Example 3 | 59.7 | 0.1 | 0 | 0 | PP | 30 | 3 | 30 | 520 | 790 |
| Example 4 | 59.7 | 0.05 | 0 | 0 | PP | 30 | 6 | 60 | 500 | 800 |
| Example 5 | 59.7 | 0.2 | 0 | 0 | PP | 10 | 0.5 | 15 | 525 | 740 |
| Example 6 | 59.7 | 0.2 | 0 | 0 | PP | 60 | 3 | 15 | 535 | 780 |
| Example 7 | 59.7 | 0.2 | 0 | 0 | EP | 30 | 3 | 15 | 530 | 770 |
| | | | | | PP | 30 | | | | |
| Example 8 | 59.7 | 0.2 | 0 | 0 | EP | 60 | 3 | 15 | 520 | 760 |
| Example 9 | 59.2 | 0.2 | 0 | 0 | PP | 30 | 1.5 | 15 | 555 | 755 |
| Example 10 | 60.6 | 0.2 | 0 | 0 | PP | 30 | 1.5 | 15 | 550 | 765 |
| Example 11 | 59.7 | 0.2 | 0.14 | 0 | PP | 30 | 1.5 | 15 | 570 | 780 |
| Example 12 | 59.7 | 0.2 | 0.14 | 0.42 | PP | 30 | 1.5 | 15 | 600 | 830 |
| Example 13 | 59.7 | 0.04 | 0 | 0 | PP | 20 | 5 | 74.625 | 465 | 700 |
| Comparative | 59.7 | 0.1 | 0 | 0 | — | — | 0 | 15 | 480 | 600 |
| Example 1 | | | | | | | | | | |
| Comparative | 59.7 | 0.1 | 0 | 0 | PP | 80 | 8 | 15 | 490 | 680 |
| Example 2 | | | | | | | | | | |

In Comparative Example 1, the electrolyte contains no carboxylate ester, resulting in poor high-temperature and room-temperature cycling performance of the lithium-ion battery. In Comparative Example 2, the electrolyte contains an excessive amount of the carboxylate ester, making the ratio of the percentage of the carboxylate ester to the percentage of element manganese (C/100B) too high, leading to poor high-temperature and room-temperature cycling performance of the lithium-ion battery under high voltage.

As shown in Examples 1 to 10, when the electrolyte contains 10% to 60% of the carboxylate ester and the ratio of the percentage of the carboxylate ester to the percentage of element manganese (C/100B) is in the range of 0.5 to 6, the high-temperature and room-temperature cycling performance of the lithium-ion battery under high voltage can be significantly improved. The improvement is particularly significant when C/100B is in the range of 1 to 3.

When the positive electrode active material contains 0.05% to 0.3% of element manganese and the ratio of the percentage of element manganese to the percentage of element cobalt (A/20B) is in the range of 10 to 60, the high-temperature and room-temperature cycling performance of the lithium-ion battery under high voltage can be further improved. The improvement is particularly significant when A/20B is in the range of 15 to 30.

Additionally, as seen from Examples 11 and 12, when the positive electrode material is further doped with other metal elements, such as Mg and/or Al, the cycling stability of the lithium-ion battery is further improved, possibly due to the introduction of more doping elements that create a more stable positive electrode material interface.

Table 2 shows the effects of additional additives in the electrolyte on the high-temperature and room-temperature cycling performance of lithium-ion batteries under high voltage. Except for the parameters listed in Table 2, Examples 14 to 18 have the same settings as Example 2.

TABLE 2

| | Percentage | | | | | |
|---|---|---|---|---|---|---|
| | of | | | Percentage | | |
| | Formula | | Percentage | of | | |
| | 1-4 | | of 1,3- | vinylene | | |
| | compound | | propane | carbonate | | |
| | in | Percentage of 1,3,6- | sultone in | in | High- | Room- |
| | electrolyte | hexanetricarbonitrile | electrolyte | electrolyte | temperature | temperature |
| | (%) | in electrolyte (%) | (%) | (%) | cycle count | cycle count |
| Example | 0 | 0 | 0 | 0 | 550 | 760 |
| 2 | | | | | | |
| Example | 2 | 0 | 0 | 0 | 600 | 850 |
| 14 | | | | | | |
| Example | 0 | 2 | 0 | 0 | 580 | 790 |
| 15 | | | | | | |
| Example | 0 | 0 | 3 | 0 | 590 | 800 |
| 16 | | | | | | |
| Example | 0 | 0 | 0 | 0.5 | 570 | 810 |
| 17 | | | | | | |
| Example | 2 | 2 | 3 | 0.5 | 630 | 880 |
| 18 | | | | | | |

The results show that adding bicyclic sulfate compounds (Formula 1-4 compound) and trinitrile compounds (1,3,6-hexanetricarbonitrile), 1,3-propane sultone, and/or vinylene carbonate to the electrolyte can further improve the high-temperature and room-temperature cycling performance of lithium-ion batteries under high voltage.

Table 3 shows the effects of the porous coating in the separator on the high-temperature and room-temperature cycling performance of lithium-ion batteries under high voltage. Except for the parameters listed in Table 3, Examples 19 to 23 have the same settings as Example 2.

TABLE 3

| | | | Adhesion | | |
|---|---|---|---|---|---|
| | | | strength | | |
| | Porous coating | | between | | |
| | Composition | | porous | | |
| | and mass | Composition | coating of | | |
| | proportion of | and mass | separator | | |
| | fluorine- | proportion of | and | High- | Room- |
| | containing | inorganic | electrode | temperature | temperature |
| | binder | particles | plate (N/m) | cycle count | cycle count |
| Example 2 | — | — | — | 550 | 760 |
| Example 19 | 20% PVDF | 80% Al₂O₃ | 4 | 600 | 810 |
| Example 20 | 30% PVDF | 70% Al₂O₃ | 7 | 640 | 850 |
| Example 21 | 40% PVDF | 60% Al₂O₃ | 12 | 700 | 900 |
| Example 22 | 60% PVDF | 40% Al₂O₃ | 20 | 590 | 800 |
| Example 23 | 40% PVDF | 60% MgOH | 12 | 700 | 900 |

The results show that using the separator with such porous coating can further improve the high-temperature and room-temperature cycling performance of lithium-ion batteries under high voltage.

Additionally, when the adhesion strength between the porous coating and the positive electrode or negative electrode is in the range of 4 N/m to 20 N/m, the high-temperature and room-temperature cycling performance of lithium-ion batteries under high voltage can be further improved.

In this specification, reference to “an embodiment”, “some embodiments”, “one embodiment”, “another example”, “an example”, “a specific example”, or “some examples” means that at least one embodiment or example in the present application includes a specific feature, structure, material, or characteristic described in this embodiment or example. Therefore, descriptions in various places throughout this specification, such as “in some embodiments”, “in these embodiments”, “in an embodiment”, “in another example”, “in an example”, “in a specified example”, or “examples”, do not necessarily refer to the same embodiment or example in the present application. In addition, a specific feature, structure, material, or characteristic herein may be combined in any appropriate manner in one or more embodiments or examples.

Although illustrative embodiments have been demonstrated and described, those skilled in the art should understand that the above embodiments are not to be construed as limiting the present application, and changes, substitutions, and modifications may be made to some embodiments without departing from the spirit, principles, and scope of the present application.

What is claimed is:

1. An electrochemical device comprising a positive electrode, a negative electrode, and an electrolyte; wherein
the positive electrode comprises a positive electrode active material, the positive electrode active material comprises element manganese; and based on a mass of the positive electrode active material, a percentage of the element manganese is B %;
the electrolyte comprises carboxylate ester; and based on a mass of the electrolyte, a percentage of the carboxylate ester is C %; and
10≤C≤60 and 0.5≤C/100B≤6.

2. The electrochemical device according to claim 1, wherein 1≤C/100B≤3.

3. The electrochemical device according to claim 1, wherein the positive electrode active material further comprises element cobalt; and based on the mass of the positive electrode active material, a percentage of the element cobalt is A %, and 10≤A/20B≤ 60 and 0.05≤B≤0.3.

4. The electrochemical device according to claim 3, wherein 15≤A/20B≤30.

5. The electrochemical device according to claim 1, wherein the positive electrode active material has a formula Li_{α}Co_{1-x-y}MnₓM_{y}O_{β}, wherein 0.95≤α≤1.4, 0≤x≤0.4, 0≤y≤0.3, 1.90≤β≤2.10, and M is at least one selected from Mg, Al, Ca, Ti, Zr, V, Cr, Fe, Ni, Cu, Zn, Ru, or Sn.

6. The electrochemical device according to claim 1, wherein the carboxylate ester comprises at least one of methyl acetate, ethyl acetate, propyl acetate, ethyl propionate, propyl propionate, butyl propionate, pentyl propionate, halomethyl acetate, haloethyl acetate, halopropyl acetate, haloethyl propionate, halopropyl propionate, halobutyl propionate, or halopentyl propionate.

7. The electrochemical device according to claim 1, wherein the electrolyte further comprises at least one of 1,3-propane sultone, vinyl sulfate, vinylene carbonate, a bicyclic carbonate compound, or a bicyclic sulfate compound.

8. The electrochemical device according to claim 7, wherein the electrolyte satisfies at least one of the following conditions:
(a) the electrolyte comprises the 1,3-propane sultone; and based on the mass of the electrolyte, a percentage of the 1,3-propane sultone is 0.5% to 5%;
(b) the electrolyte further comprises the vinyl sulfate; and based on the mass of the electrolyte, a percentage of the vinyl sulfate is 0.1% to 1%;
(c) the electrolyte further comprises the vinylene carbonate; and based on the mass of the electrolyte, a percentage of the vinylene carbonate is 0.1% to 1%;
(d) the electrolyte further comprises the bicyclic carbonate compound; and based on the mass of the electrolyte, a percentage of the bicyclic carbonate compound is 0.1% to 30%; or
(e) the electrolyte further comprises the bicyclic sulfate compound; and based on the mass of the electrolyte, a percentage of the bicyclic sulfate compound is 0.1% to 5%.

9. The electrochemical device according to claim 7, wherein the electrolyte further comprises the bicyclic carbonate compound; and the bicyclic carbonate compound comprises at least one of the following compounds:

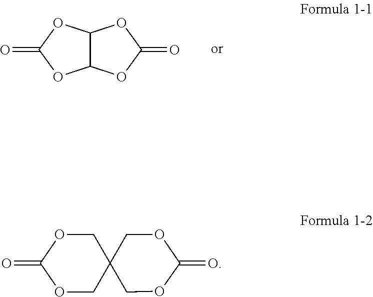 [SMILES: O=C1OC2OC(=O)OC2O1 ; O=C1OCC2(CO1)COC(=O)OC2]

10. The electrochemical device according to claim 7, wherein the electrolyte further comprises the bicyclic sulfate compound; and the bicyclic sulfate compound comprises at least one of the following compounds:

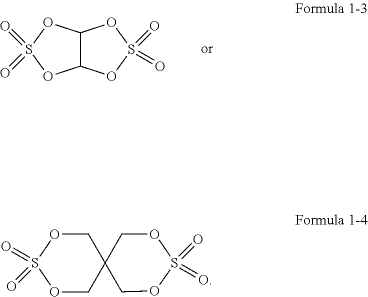 [SMILES: O=S1(=O)OC2OS(=O)(=O)OC2O1 ; O=S1(=O)OCC2(CO1)COS(=O)(=O)OC2]

11. The electrochemical device according to claim 1, wherein the electrolyte further comprises a trinitrile compound; wherein the trinitrile compound comprises at least one of 1,3,5-pentanetricarbonitrile, 1,2,3-propanetricarbonitrile, 1,3,6-hexanetricarbonitrile, or 1,2,3-tris(2-cyanoethoxy) propane; and
based on the mass of the electrolyte, a percentage of the trinitrile compound is 0.1% to 10%.

12. The electrochemical device according to claim 1, wherein the electrolyte further comprises a lithium salt; wherein the lithium salt comprises at least one of lithium hexafluorophosphate, lithium bis(trifluoromethanesulfonyl)imide, lithium bis(fluorosulfonyl)imide, lithium tetrafluoroborate, lithium bis(oxalato) borate, lithium difluoro (oxalato) borate, or lithium difluorophosphate.

13. The electrochemical device according to claim 1, wherein the electrochemical device further comprises a separator, wherein the separator comprises a porous substrate and a porous coating disposed on at least one side of the porous substrate, and the porous coating comprises inorganic particles and a fluorine-containing binder.

14. The electrochemical device according to claim 13, wherein the inorganic particles comprise at least one of magnesium hydroxide, boehmite, or aluminum oxide, and the fluorine-containing binder is a polyvinylidene fluoride-based binder.

15. The electrochemical device according to claim 13, wherein an adhesion strength between the porous coating and the positive electrode or the negative electrode is 4 N/m to 20 N/m.

16. An electronic device comprising an electrochemical device, the electrochemical device comprises a positive electrode, a negative electrode, and an electrolyte; wherein
the positive electrode comprises a positive electrode active material, the positive electrode active material comprises element manganese; and based on a mass of the positive electrode active material, a percentage of the element manganese is B %;
the electrolyte comprises carboxylate ester; and based on a mass of the electrolyte, a percentage of the carboxylate ester is C %; and
10≤C≤60 and 0.5≤C/100B≤6.

17. The electronic device according to claim 16, wherein 1≤C/100B≤3.

18. The electronic device according to claim 16, wherein the positive electrode active material further comprises element cobalt; and based on the mass of the positive electrode active material, a percentage of the element cobalt is A %, and 10≤A/20B≤60 and 0.05≤B≤0.3.

19. The electronic device according to claim 18, wherein 15≤A/20B≤30.

20. The electronic device according to claim 16, wherein the positive electrode active material has a formula Li_{α}Co_{1-x-y}MnₓM_{y}O_{β}, wherein 0.95≤α≤1.4, 0≤x≤0.4, 0≤y≤0.3, 1.90≤β≤2.10, and M is at least one selected from Mg, Al, Ca, Ti, Zr, V, Cr, Fe, Ni, Cu, Zn, Ru, or Sn.
